(19) United States
(12) Patent Application Publication
(10) Pub. No.: US 2006/0070429 A1
(43) Pub. Date: Apr. 6, 2006

(54) Water quality measuring apparatus

(76) Inventor: Yi-Chia Liao, Miaoli County (TW)

Correspondence Address: BIRCH STEWART KOLASCH & BIRCH, PO BOX 747, FALLS CHURCH, VA, 22040-0747, US

(21) Appl. No.: 10/957,667

(22) Filed: Oct. 5, 2004

(51) Int. Cl. G01N 11/00

(52) U.S. Cl. 73/64.53; 73/53.01; 73/863

(57) ABSTRACT

The present invention discloses a water quality measuring apparatus, which comprises a body in the shape of a flat panel being installed in a recession, and the recession is used to contain some sample water for measuring water quality and a positive/negative probe in the recession is used to transmit an electric charge signal of the sample water to a sampling unit of the body and then after a microprocessor calculates the level of water quality, a reading display unit on the body informs users about the level of water quality of the sample water. Therefore, the invention provides a portable and easy-to-use water quality measuring apparatus and allows users to measure the level of water quality anytime.

### FIELD OF THE INVENTION

The present invention relates to a water quality measuring apparatus, more particularly to an easy-to-use and convenient-to-carry water quality measuring apparatus.

### BACKGROUND OF THE INVENTION

As our living standard gets higher, people pay more attention to their health. Drinking water is an integral part of our daily life and also one of the key factors affecting our health. Please refer to FIG. 1 for a prior-art water quality measuring meter 1 to assure a clean sources of our daily drinking water, which comprises a body 2, a measuring cap 3, a microprocessor 4 installed in the body 2, a sampling unit 5 and a reading display unit 6. The measuring cap 3 can be installed at a distal end of the body 2 and the body 2 comprises a positive/negative probe 7 installed at the distal end of the body 2, such that a user can use the measuring cap 3 to contain a certain specific measuring sample of water and extend the distal end of the body 2 into the measuring cap 3. The positive/negative probe 7 obtains an electric charge signal of the sample water and sends the signal to the microprocessor 4 through the sampling unit 5. The water quality of the sample water is known after the sample water is processed by the microprocessor 4, and the user is informed about the level of water quality by the reading display unit 6.

Although the prior art can provide a convenient and portable water quality meter, yet the measuring cap 3 may be lost easily since the measuring cap 3 is detachable from the body 2. Further, the user may dip the body 2 into the measuring sample water for convenience or when the measuring cap 3 is lost, which may contaminate the sample water and cause the sample water unable to be used for further purposes. Furthermore, if the quantity of water contained in the measuring cap 3 is insufficient, it will affect the accuracy of the measured water quality. Obviously, such prior art may contaminate sample water, lose the measuring cap, and causes errors to the accuracy of measurement due to the user's improper use and habits.

### SUMMARY OF THE INVENTION

Therefore, the primary objective of the present invention is to overcome the foregoing shortcomings and avoid the exiting deficiency by providing a portable and easy-to-use water quality measuring apparatus to prevent errors of measuring water quality due to user's improper use. Furthermore, the invention only requires several cubic centimeters of sample water for the measurement and will not contaminate the whole measuring sample water, so that the rest of sample water can be used further.

The water quality measuring apparatus in accordance with the present invention comprises a reading display unit, a sample unit, a microprocessor, a positive/negative probe and a power supply unit. The sample unit is connected to the positive/negative probe; the reading display unit and the sampling unit are separately connected to the microprocessor; the power supply unit provides the required electric power source. The water quality measuring apparatus has a body in the shape of a flat panel, and the body has a recession. The reading display unit, sampling unit, microprocessor and power supply unit are installed in the body, and the positive/negative probe is installed at the bottom of the recession. The recession is used to contain some measuring sample water, and the positive/negative probe measures an electric charge signal of the sample water and transmits the signal to the sampling unit and then to the microprocessor from the sampling unit. After the signal is computed by the microprocessor, the level of water quality is obtained and displayed on the reading display unit.

To make it easier for our examiner to understand the objective of the invention, its structure, innovative features, and performance, we use a preferred embodiment and the attached drawings for the detailed description of the invention.

### BRIEF DESCRIPTION OF THE DRAWINGS

FIG. 1 is a perspective view of a prior-art water quality measuring apparatus.

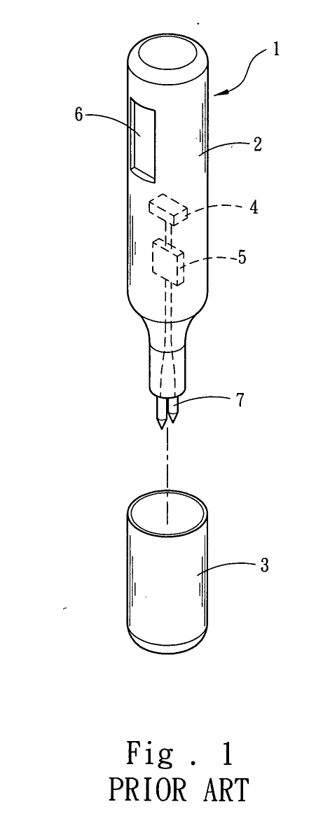

FIG. 2 is a perspective view of the water quality measuring apparatus of the present invention.

FIG. 3 is a functional block diagram of the water quality measuring apparatus of the present invention.

FIG. 4 is a perspective view of the water quality measuring apparatus according to another preferred embodiment of the present invention.

FIG. 5 is a functional block diagram of the water quality measuring apparatus according to another preferred embodiment of the present invention.

FIG. 6 is a perspective view of the water quality measuring apparatus according to a further preferred embodiment of the present invention.

### DETAILED DESCRIPTION OF THE PREFERRED EMBODIMENTS

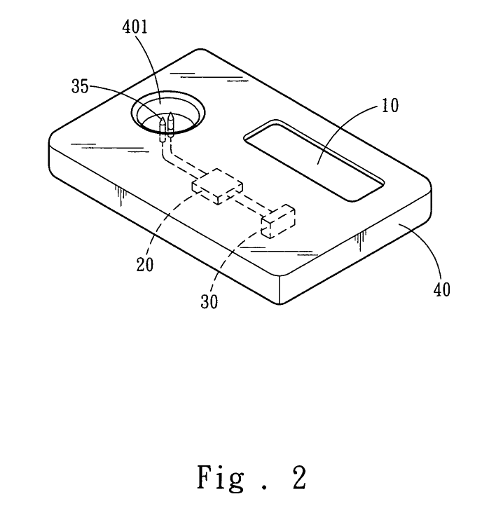

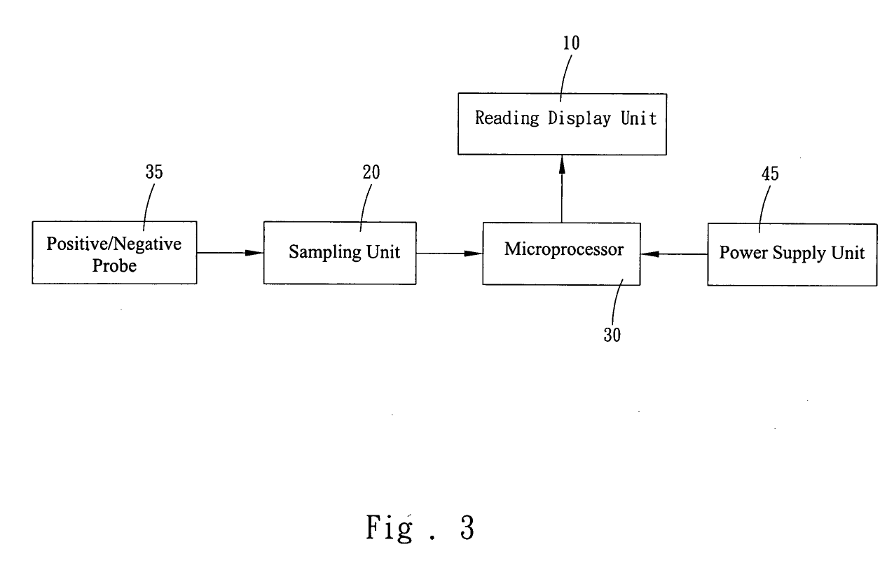

With reference to FIGS. 2 to 3, a water quality measuring apparatus comprises a reading display unit 10, a sampling unit 20, a microprocessor 30, a positive/negative probe 35, a power supply unit 45, said sampling unit 20 is coupled to the positive/negative probe 35, and the reading display unit 10 and the sampling unit 20 are coupled separately to the microprocessor 30, and the power supply unit 45 is used to supply the required electric power supply.

The water quality measuring apparatus comprises a body 40 in the shape of a flat panel and the body 40 has a recession 401. The reading display unit 10, sampling unit 20, microprocessor 30 and power supply unit 45 are installed inside the body 40. The positive/negative probe 35 is installed at the bottom of the recession 401, and the recession 410 is used to contain the measuring sample water. The positive/negative probe 35 transmits the measured electric charge signal of the sample water to the sampling unit 20 and then the sampling unit 20 transmits the signal to the microprocessor 30. After the microprocessor 30 completes the computation, the level of water quality will be displayed on the reading display unit 10, and the reading display unit 10 could be made of a liquid crystal display (LCD) device. Further, the reading display unit 10 has a plurality of symbols indicating the levels of water quality and informing users about the water quality of the currently measured sample water. These symbols could be texts, numerals or graphics; wherein the texts include “Good”, “Fair” or “Bad” to inform users about the levels of water quality of the sample water.

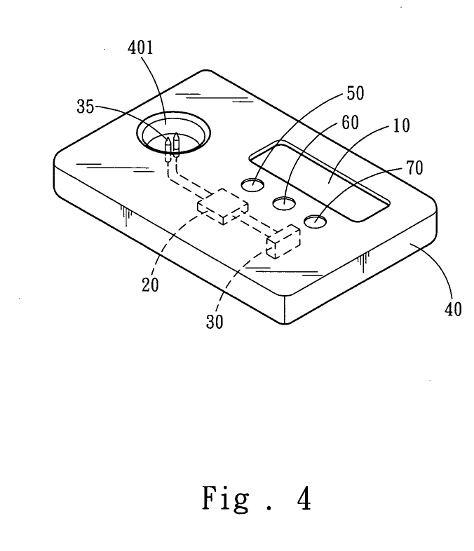

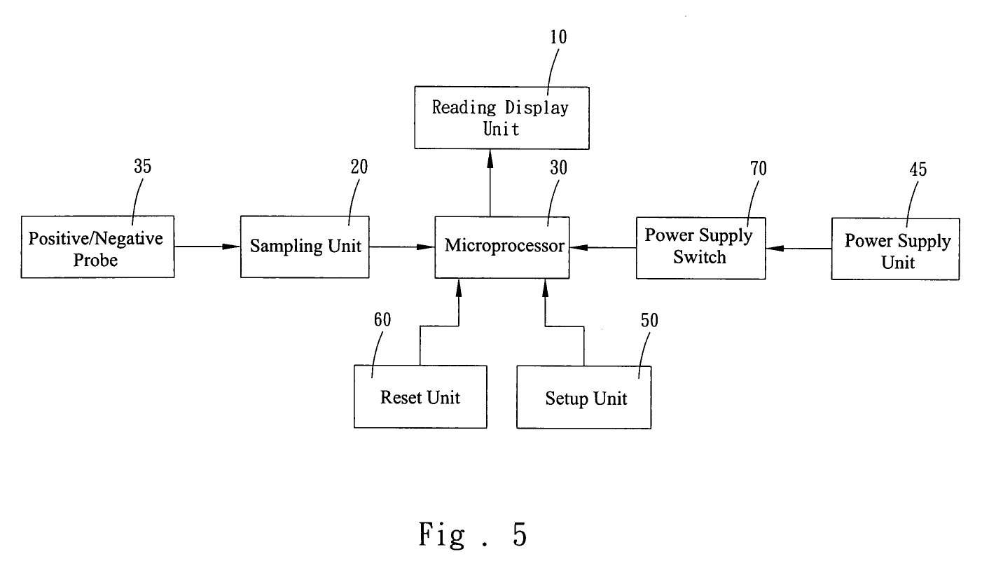

With reference to FIGS. 4 to 5, the water quality measuring apparatus further comprises a setup unit 50, so that if a user requires a higher standard for the water quality, the user can use the setup unit 50 to set the levels of water quality represented by the symbols of the reading display unit 10; so that a user can use the setup unit 50 to change the original setup for displaying “Good” if the suspending particles contained in the water is below 200 ppm to a new setup for displaying “Good” if the suspending particles contained in the water is below 100 ppm. Further, the water quality measuring apparatus comprises a reset unit 60 for resetting the symbols of the reading display unit 10 for indicating the levels of water quality as to facilitate users to set the values back to the original values after being changed by the setup unit 50.

The water quality measuring apparatus according to the present invention further comprises a power supply switch 70 for controlling a switch of the power supply unit 45 and saving power. The power supply unit 45 could be a mercury battery for saving space or a solar energy battery for saving the trouble of replacing batteries. After any of the foregoing batteries is adopted for the power supply unit 45, the dimensions of the water quality measuring apparatus of the present invention can be reduced to those of a business card, which allows users to carry and use the water quality measuring apparatus anytime.

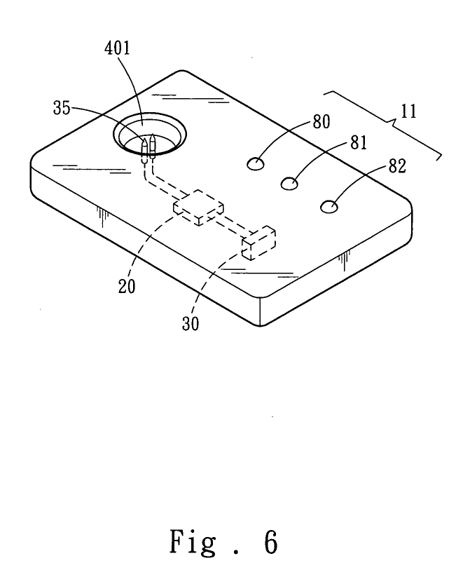

With reference to FIG. 6, the reading display unit 11 comprises a passed lamp 80 and a failed lamp 81 for informing users whether or not the level of water quality meets the desired standard. The advantage of these lamps allows users to determine the water quality easily by the lighting of these lamps. The passed lamp 80 and the failed lamp 81 may adopt different colors, such as green color for the passed lamp 80 and red color for the failed lamp 81, so that a user can distinguish the water quality at a glance. The reading display unit 11 further comprises a warning lamp 82, so that it alerts users and prepares them for the situation of failed level when the water quality approaches a critical level.

When the aforementioned water quality measuring apparatus is in use, several cubic centimeters of measuring sample water are put into the recession 401, and the sampling unit 20 and the microprocessor 30 are used to compute the water quality of the sample water, and the reading display unit 10, 11 is used to display the reading. The water quality measuring apparatus can be made to the size of a business card to make it easier to carry. Therefore, the invention provides a portable and easy-to-use water quality measuring apparatus to prevent errors to the water quality measurement caused by the user's improper use. Since only several cubic centimeters of sample water are used for the measurement, therefore the measuring sample water will not be contaminated and the rest of sample water can be used further.

What is claimed is:

1. A water quality measuring apparatus, comprising a reading display unit, a sampling unit, a microprocessor, a positive/negative probe and a power supply unit, and said sampling unit being coupled to said positive/negative probe, and said reading display unit and said sampling unit being separately coupled to said microprocessor, and said power supply unit being used to supply the required electric power supply; characterized in that a body in a flat panel shape having a recession and said reading display unit, said sampling unit, said microprocessor and said power supply unit being installed inside said body, and said positive/negative probe being installed at the bottom of said recession, and said recession being used for containing some measuring sample water, and said positive/negative probe transmitting an electric charge signal of said sample water measured by said positive/negative probe to said sampling unit and said electric charge signal being transmitted to said microprocessor, and said reading display unit displaying the level of water quality after the calculation by said microprocessor.

2. The water quality measuring apparatus of claim 1, wherein said reading display unit is a liquid crystal display device and has a plurality of symbols indicating the level of water quality.

3. The water quality measuring apparatus of claim 2 further comprises a setup unit for setting up said symbols indicating the levels of water quality for said reading display unit.

4. The water quality measuring apparatus of claim 3 further comprising a reset unit for resetting said symbols indicating the levels of water quality for said reading display unit to their original set values.

5. The water quality measuring apparatus of claim 2, wherein said symbols of said reading display unit is comprised of texts.

6. The water quality measuring apparatus of claim 2, wherein said symbols of said reading display unit is comprised of numerals.

7. The water quality measuring apparatus of claim 2, wherein said symbols of said reading display unit is comprised of graphics.

8. The water quality measuring apparatus of claim 1 further comprising a power supply switch for controlling a switch of said power supply unit.

9. The water quality measuring apparatus of claim 1, wherein said power supply unit is a mercury battery.

10. The water quality measuring apparatus of claim 1, wherein said power supply unit is a solar energy battery.

11. The water quality measuring apparatus of claim 1, wherein said reading display unit comprises a passed lamp and a failed lamp for providing information on the condition of said sample water passing and failing a standard respectively.

12. The water quality measuring apparatus of claim 11, wherein said passed lamp and failed lamp are of different colors.

13. The water quality measuring apparatus of claim 11, wherein said reading display unit comprises an alarm lamp for giving a warning to users if the level of water quality reaches a critical reading.
